(19) United States
(12) Patent Application Publication
(10) Pub. No.: US 2003/0014509 A1
(43) Pub. Date: Jan. 16, 2003

(54) Account management module user interface

(76) Inventor: Anthony J. Jurado JR., Highland, MI (US)

Correspondence Address: HOGAN & HARTSON LLP, ONE TABOR CENTER, SUITE 1500, 1200 SEVENTEEN ST., DENVER, CO, 80202, US

(21) Appl. No.: 09/907,209

(22) Filed: Jul. 16, 2001

(51) Int. Cl. G06F 15/173; G06F 15/16

(52) U.S. Cl. 709/223; 709/203

(57) ABSTRACT

The present invention provides a method and apparatus for an account management module user interface for NIS servers. According to one embodiment, the account management module is a set of servlets written in a platform independent programming language, such as Java, that allow system administrators to modify, add, or delete NIS information related to users. These users may be humans or other system related machines or programs. According to another embodiment, the servlets stored in a backend database provide screens in a browser. In particular there are three screens which are of importance to the present invention, and include one to display the NIS password, another to display the group maps, and the last to display the auto_home maps. These screens are interactive, which means that system administrators can manipulate the information displayed on the screens.

### BACKGROUND OF THE INVENTION

1. Field of the Invention

The present invention relates primarily to the field of servers in computer systems, and in particular to a method and apparatus for an account management module user interface for Naming Information System (NIS) servers.

Portions of the disclosure of this patent document contains material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

NIS servers are being used by several companies to manage the work of NIS masters and other system administrators to add, modify, and delete user information. These servers help in providing services to the users based on their status within the company. These services include access to programs, databases, and other hardware equipment. But since these servers have to be manually updated to include the current status of employees within the company, they are not always up to date.

System administrators and NIS masters are the only ones who have access to alter information on the NIS server, and even though a company may have a schedule and procedure that needs to be followed, most NIS masters and system administrators have their own schedule, which may not be uniform throughout the company. This non-uniform schedule is sometimes due to the nature of the work carried out on a server. For example, some servers are used to test programs or products manufactured by the company. These servers have to be updated more regularly so that all employees authorized to use the server have access to the most current and up to date information. Other servers merely manage the smooth running of services like email and do not need updating as regularly.

Furthermore, present systems do not have an user interface that allows system administrators and NIS masters to make changes which are easy and intuitive. Currently NIS masters must make changes at a very rudimentary level compelling system administrators and NIS masters to know rudimentary programming languages. They also do not have direct access to the Human Resources (HR) database of the company. Since the HR department is presumably up to date with the status of all employees within the company, having direct access to their database would ensure current and up to date information about all employees. Both of these requirements would allow system administrators and NIS masters to make changes, even if they are made on a schedule that is not uniform throughout the entire company, and this ensures that only valid employees have access to company information.

Due to the lack of a user interface some system administrators may forget to remove the name and access of an employee who no longer works for the company, and this could lead to the ex-employee being able to access the server and hence the programs, database, and other hardware equipment based on his/her employment status within the company prior to leaving. This could lead to a breach in security, and furthermore, names of ex-employees along with all of their information remains in the NIS database occupying precious memory space.

### SUMMARY OF THE INVENTION

The present invention provides a method and apparatus for an account management module user interface for servers. According to one embodiment of the present invention, the server is a Naming Information System (NIS) server. In another embodiment, the account management module is written in a platform independent programming language. It allows system administrators to modify, add, or delete information from the server related to users.

According to another embodiment of the present invention, the account management module is a set of servlets written in a platform independent programming language, such as Java, that allow system administrators to modify, add, or delete NIS information related to users. These users may be humans or other system related machines or programs. According to another embodiment, the servlets along with a set of proprietary procedures that are stored in a backend database provide screens in any browser.

In particular one embodiment uses three screens which are of importance to the present invention, and include one to display the NIS password, another to display the group maps, and the last to display the auto_home maps. These screens are interactive, which means that system administrators can manipulate the information displayed on the screens.

### BRIEF DESCRIPTION OF THE DRAWINGS

These and other features, aspects and advantages of the present invention will become better understood with regard to the following description, appended claims and accompanying drawings where:

FIG. 1 is a flowchart illustrating a NIS domain maintenance screen.

FIG. 2 is a flowchart illustrating the main components of a NIS domain maintenance screen.

FIG. 3 is a flowchart illustrating the creation of a new NIS domain.

FIG. 4 is a flowchart illustrating the modification of an existing NIS domain.

FIG. 5 is a flowchart illustrating the deletion of an existing NIS domain.

FIG. 6 is a flowchart illustrating a NIS group maintenance screen.

FIG. 7 is a flowchart illustrating the main components of a NIS group maintenance screen.

FIG. 8 is a flowchart illustrating the creation of a new NIS group.

FIG. 9 is a flowchart illustrating the modification of an existing NIS group.

FIG. 10 is a flowchart illustrating the deletion of an existing NIS group.

FIG. 11 is a flowchart illustrating the addition of new members to existing NIS groups.

FIG. 12 is a flowchart illustrating the removal of existing members from a NIS group.

FIG. 13 is a flowchart illustrating the creation of a new global NIS group.

FIG. 14 is a flowchart illustrating a NIS system user's maintenance screen.

FIG. 15 is a flowchart illustrating the main components of a NIS system user's maintenance screen.

FIG. 16 is a flowchart illustrating the creation of a new NIS system user.

FIG. 17 is a flowchart illustrating the modification of an existing NIS system user.

FIG. 18 is a flowchart illustrating the deletion of an existing NIS system user.

FIG. 19 is a flowchart illustrating the creation of a new global system user.

FIG. 20 is an illustration of an embodiment of a computer execution environment.

### DETAILED DESCRIPTION OF THE INVENTION

The invention is a method and apparatus for an account management module user interface for servers. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

NIS Server

A NIS server is used by one embodiment of the present invention. A NIS server has three kinds of users that access its database to create, modify, or delete data. These users are helped by three interactive screens to carry out their tasks optimally. These users comprise of the NIS Domain users, who are helped by a NIS Domain Maintenance screen to manage the NIS domains, the NIS Group users, who are helped by a NIS Group Maintenance screen to manage the groups within the NIS domain, and the NIS System users, who are not humans but programs that provide a way to create an account that an application can use to perform a variety of support tasks, who are helped by a NIS System User Maintenance screen.

The Group Maintenance and System User Maintenance screens are accessible only from the buttons found in the NIS Domain Maintenance screen, and since the NIS Domain Maintenance screen is accessible by system administrators and other personal who have the authority to do so, there is no misuse of these screens by unauthorized users.

NIS Screens

The three screens of one embodiment of the present invention, viz. The NIS Domain Maintenance, the NIS Group Maintenance, and the NIS System User Maintenance screens do share some commonality, and include:

(a) Status: The status of the last command is always displayed, for instance, in the top left area between the screen title and the top horizontal line. All NIS screens indicate a status message of “Ready” upon initial loading. Selecting a button on the screen causes this status to be replaced by the results of the selected button's action.

(b) Dynamic Component Display: Some components of all screens are dynamically resized, added, or removed depending upon the buttons selected. For example, if a NIS domain is selected in the select box and the “Select” button is pressed, the select box, which displays the list of NIS domains, changes from 15 rows to 5 rows to use less screen space.

(c) Passwords: All passwords entered in a NetAdmin screen is immediately encrypted, and stored in this form in a database for future reference. But since the password is encrypted, it is not possible for anyone to retrieve the password if the user forgets his/her password in the future.

(d) History: All changes made through the NIS screens are recorded in a history table for future reference.

The user interface for the NIS servers is 3 screens collectively called the NIS Domain Maintenance screens. The NIS Domain Maintenance screens are used to maintain information pertaining to NIS domains which exist in the namespace domain of a company. A complete description about NIS servers, and the NetAdmin Account Management Module (AMM) used to maintain employee records on the NIS servers is contained in co-pending U.S. patent application “Account Management Module Database Interface”, Ser. No. ₋₋₋/₋₋₋,₋₋₋filed on ₋₋₋,₋₋₋, and assigned to the assignee of this patent application.

The NetAdmin provides the following services for NIS domains, which can be easily accessible and maintained using the intuitive user interface provided by this application, and include:

(a) The NIS password, group, auto_home, and aliases maps can be automatically managed using the amm.jar program to pull information from the NetAdmin database.

(b) The NIS host map can be maintained using the nahost program.

(c) Global NIS groups and global NIS system users can be reserved. In order to better understand these services, a thorough understanding of the three screens is needed, and their inner workings are explained below.

NIS Domain Maintenance

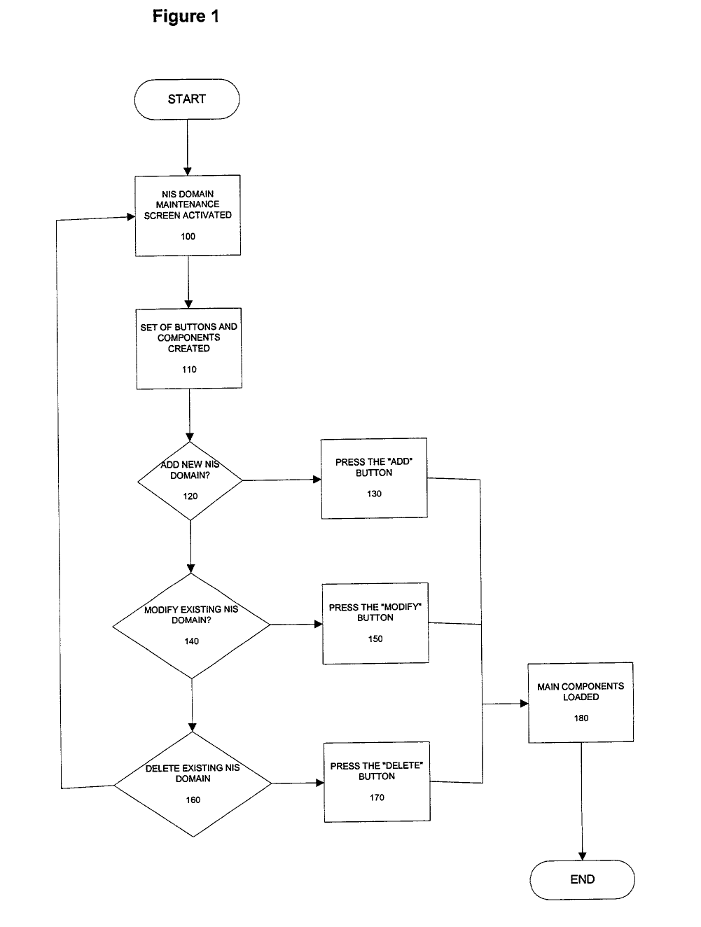

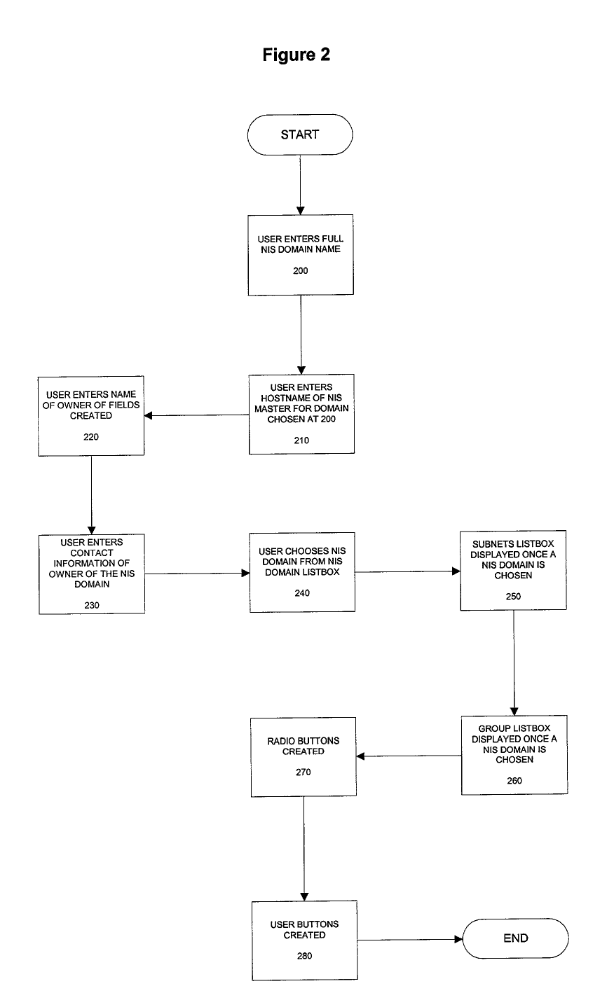

A NIS Domain Maintenance screen, according to one embodiment of the present invention, is illustrated in FIG. 1. At step 100, a NIS Domain Maintenance screen is activated. At step 110, it starts up with a set of buttons and components that support selecting, creating, and deleting a NIS domain. If a new NIS domain is needed at step 120, then a new NIS domain can be added to the list by entering the relevant information and pressing the “Add” button at step 130. If an existing NIS domain needs modification at step 140, then it can be modified at step 150 by pressing the “Modify” button. If an existing NIS domain needs to be deleted at step 160, then it is removed by pressing the “Delete” button at step 170. At step 180, the main components, which are locations that require user input, of this screen along with their functionality are loaded. These components are discussed in further detail below, and one embodiment of the present invention is illustrated in FIG. 2, where: p1 (a) NIS Domain Name: The user enters the full name of the NIS domain, which is seen at step 200. This name is case sensitive, and by convention, should end in the “.company name.domain name”, especially if it is a production domain name. For example, “.Sun.COM”, or “.Nasa.GOV”.

(b) NIS Master's Hostname: The user enters the hostname of the NIS master for the NIS domain mentioned in (a) above, which is seen at step 210. The hostname has to be in “host.domain” format, e.g. star.eng. The hostname entered will only work if it has been previously registered using the “Host Maintenance” screen.

(c) Owner: The user enters the name of the owner of fields (a) and (b) above, which is seen at step 220. There is a “search” button provided that can be clicked to reveal a list of all owners pertaining to the names provided in fields (a) and (b) above.

(d) Contact: The user enters the person's name who is responsible for supporting the NIS domain in question, which is seen at step 230. Here too a “search” button is provided to reveal a list of all personnel responsible for maintaining the NIS domain mentioned in fields (a) and (b) above.

(e) NIS Domain Listbox: This is a box that contains the names of all existing NIS domains, and is titled “Select from”. This box reveals up to 15 names at a time which can be scrolled down for more (if there are any) when the screen is first loaded. At step 240, the user chooses one NIS domain from the list. After a NIS domain has been selected, this list is reduced to 5 names to conserve screen space.

(f) Subnets Listbox: Once a NIS domain has been selected, a listbox titled “Subnets” is displayed, which is seen at step 250. This list displays all subnets that are associated with this NIS domain. This listbox is for display purposes only, and a user will not be able to take any actions on the subnets from this screen. The “NIS Subnets” screen has to be used to modify the subnet's NIS association.

(g) Groups Listbox: This box is displayed along with the Subnets Listbox, and is seen at step 260. This box contains the names of all existing NIS groups associated with the NIS domain chosen at step 240 above, and is titled “Groups”. Like the Subnets Listbox this one is for display purposes only, and any modification to a group has to be made using the “NIS Groups” screen.

(h) Transition Complete: This is a pair of radio buttons that indicate with a “Yes”or a “No” whether or not the current selected NIS domain is ready to use the amm.jar pull program to manage its password, group, and auto_home maps, which is seen at step 270. It must be noted here that changing the transition status button to “No” disables the NIS master for the selected NIS domain from pulling new NIS information from the NetAdmin. In other words, the NIS master will not be able to pull the password, shadow, group, and auto_home maps.

(i) A set of buttons are created at step 280. These buttons comprise of:

(1) Select: This button is used to load the information from an existing NIS domain.

(2) Add: This button is used to create a new NIS domain.

(3) Modify: This button is used to modify an existing NIS domain.

(4) Delete: This button is used to delete an existing NIS domain.

(5) Reset: This button is used to reset the values back to what they were when the screen was first loaded (usually the default values). This button is not displayed unless a NIS domain is selected.

(6) Groups: This button is used to switch to the NIS Group Maintenance screen (one of the three interactive screens) for the NIS domain selected.

(7) Global Groups: This button is used to switch to the “NIS Groups” screen in order to review or update the NIS group information for global NIS groups.

(8) System Users: This button is used to switch to the NIS System User Maintenance screen (one of the three interactive screens) for the NIS domain selected.

(9) Global System Users: This button is used to switch to the “NIS System Users” screen in order to create, modify, or delete global system users.

The steps needed to create, modify, and delete a NIS domain are mentioned next.

Creating A New NIS Domain

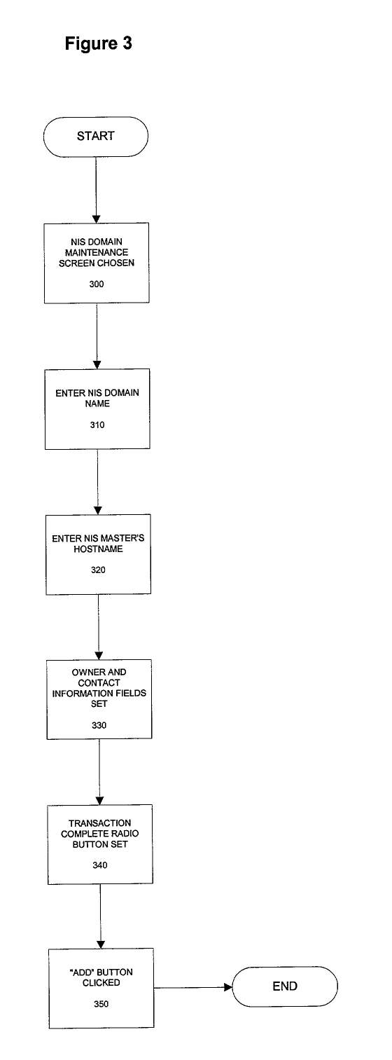

Creating a new NIS domain, according to one embodiment of the present invention, is illustrated in FIG. 3, where at:

Step 300: The ‘NIS Domain Maintenance’ link is chosen from the NetAdmin navigation menu. When the screen is displayed, the ‘NIS Domain Name’ and the ‘NIS Master's Hostname’ text fields are empty. The ‘Owner’ and ‘Contact’ text fields default to the user's information, and the ‘Transaction Complete’ radio button will default to “No”.

Step 310: The NIS Domain Name is entered.

Step 320: The NIS Master's Hostname is entered.

Step 330: The Owner and Contact fields are set. These fields only need to be changed if the owner or contact for the domain is not the same as the user.

Step 340: An appropriate value for the ‘Transaction Complete’ radio button is set. The button is set to ‘Yes’ if there is no data to be bulk loaded, and set to ‘No’ if there is data to be bulk loaded.

Step 350: The “Add” button is clicked to add the new NIS domain.

Modify Information Of An Existing NIS Domain

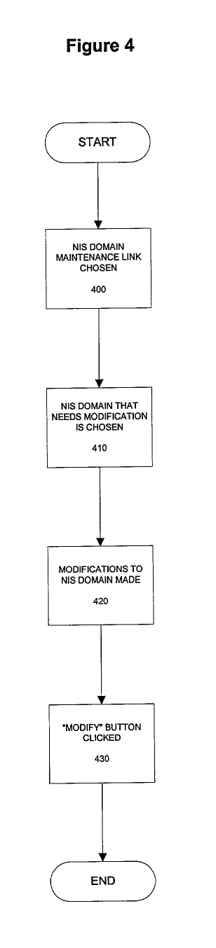

It is possible to modify the NIS Domain Name, NIS Master's Hostname, Owner, Contact, and Transaction status fields using the NIS Domain Maintenance screen. An embodiment of this is illustrated in FIG. 4, where:

Step 400: The ‘NIS Domain Maintenance’ link from the NetAdmin navigation menu is clicked. The ‘NIS Domain Maintenance’ screen is displayed with all text fields empty.

Step 410: The ‘NIS domain that needs modification in the NIS Domains’ listbox is highlighted. Click on the ‘Select’ button, and the NetAdmin refreshes the page with the information for the selected NIS domain displayed in the screen components.

Step 420: Changes to the existing displayed values are made.

Step 430: The “Modify” button is clicked to record the changes made at step 420 above.

Deleting An Existing NIS Domain

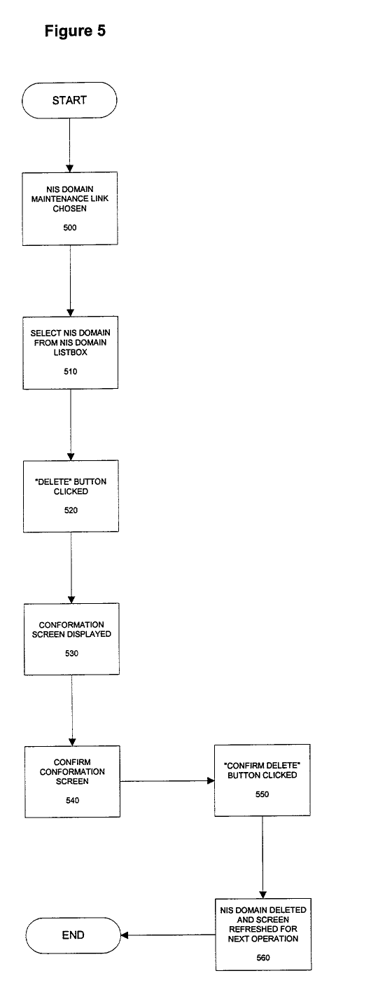

Deleting an existing NIS domain, according to one embodiment of the present invention, is illustrated in FIG. 5. By deleting a NIS domain, the NIS master for that domain is handicapped as well, since it cannot run the amm.jar pull, and nahost pull programs. The steps in deleting a NIS domain are describe below, where:

Step 500: A ‘NIS Domain Maintenance’ link from the NetAdmin navigation menu is chosen. The ‘NIS Domain Maintenance’ screen is displayed with all text fields empty.

Step 510: The ‘NIS domain that needs to be deleted in the NIS Domains’ listbox is highlighted. The “Delete” button is clicked at step 520. At this point the NetAdmin displays a confirmation screen. This screen is seen at step 530.

Step 540: The newly displayed confirmation screen is created. After confirming that the target NIS domain is correct, the “Confirm Delete” button is clicked at step 550. NetAdmin deletes the NIS domain and refreshes the screen for another operation at step 560.

NIS Group Maintenance

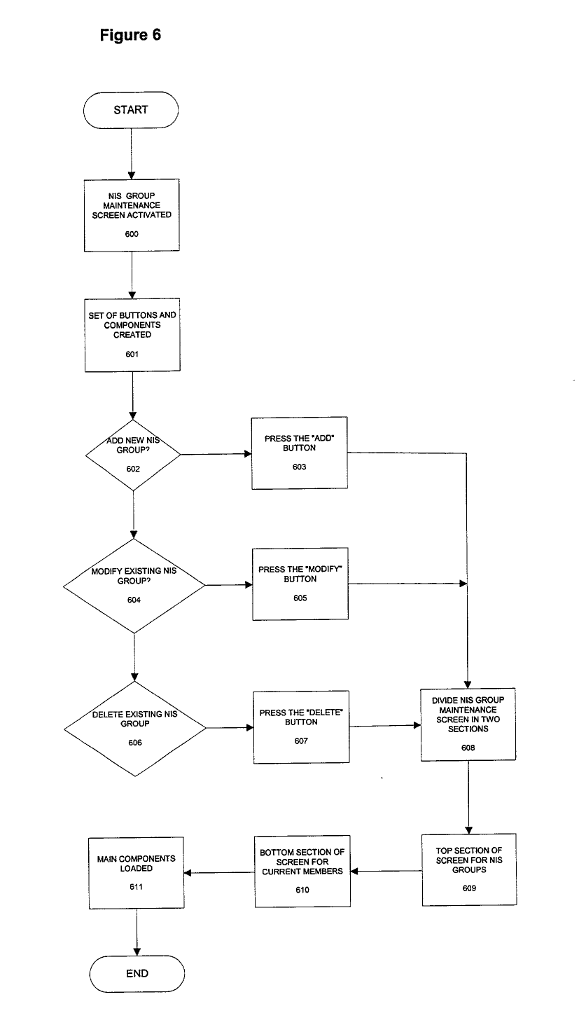

A NIS Group Maintenance screen, according to one embodiment of the present invention, is illustrated in FIG. 6. At step 600, a NIS Group Maintenance screen is activated. This screen starts up at step 601 with a set of components and buttons that support selecting, creating, or deleting a NIS group. If a new NIS group is needed at step 602, then a user can enter the information for a new NIS group into the screen components and click the “Add” button to create a new NIS group at step 603. If an existing NIS group needs modification at step 604, it can be modified by selecting a NIS group from a list and clicking on the “Modify” button at step 605. If an existing NIS group needs to be deleted at step 606, it can be deleted by selecting a NIS group from a list and clicking on the “Delete” button at step 607.

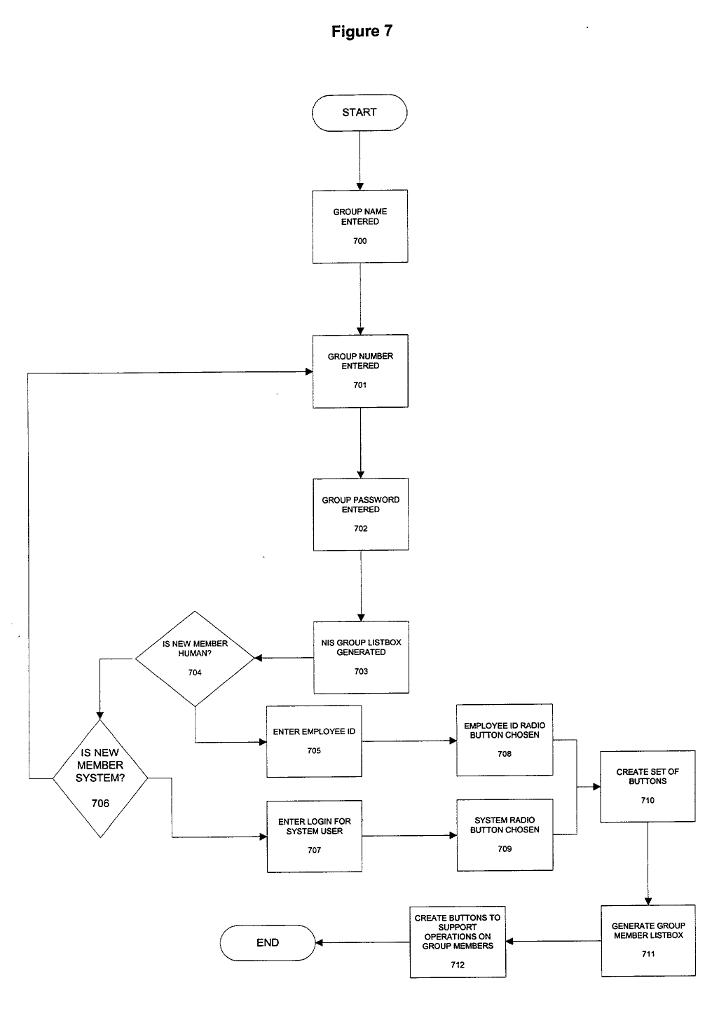

The NIS group Maintenance screen can only be accessed by clicking on either the ‘NIS Groups’ or the ‘Global NIS Groups’ button in the ‘NIS Domain Maintenance’ screen. The NIS Group Maintenance screen is divided into two sections, which is seen at step 608. The top section is used to maintain information about the NIS groups, and is illustrated at step 609, the bottom section is used to maintain information about the members of the current selected group, and is illustrated at step 610. At step 611, the main components, which are locations that require user input, of this screen along with their functionality are loaded. These components are discussed in further detailed below, and according to one embodiment of the present invention is illustrated in FIG. 7, where:

(a) Group Name: This is the name of the NIS group, which is the one that shows up in the generated group file, and is seen at step 700. Group names are always lower case characters, and they cannot match any existing group name in the selected NIS domain, or any existing global group name.

(b) Group Number: This is the group number for this NIS group, and is seen at step 701. This number is all digits, and it cannot match any existing group number in the selected NIS domain, or any existing global group number.

(c) Group Password: This is the password for this NIS group, and is seen at step 702. This filed is not mandatory to fill up. If a password is chosen, then the password which has two text fields has to be both filled with the same password.

(d) NIS Group Listbox: The NIS group listbox is generated at step 703. This is a listbox titled ‘Select from the following groups’, which displays all of the existing NIS groups (if any exists).

(e) Member Name or Employee ID: If the new user to be added is a human at step 704, then the Employee ID of the person is entered at step 705. If the new user to be added is a system user at step 706, the login for the system user is entered at step 707. Both the Employee ID and the login have to be active and pre-registered.

(f) Member Type: If the new user to be added is a human at step 704, then the employee id radio button is clicked at step 708, else if the new user to be added is a system user at step 706, then the system radio button is clicked at step 709.

(g) : A set of buttons are created at step 710. These buttons comprise of:

(1) Select: This button is used to load the information for an existing NIS group.

(2) Add: This button is used to create a new NIS group.

(3) Modify: This button is used to modify a current selected NIS group.

(4) Delete: This button is used to delete a current selected NIS group. There is no confirmation when deleting NIS groups.

(h) Group Member Listbox: The group member listbox is generated at step 711. This is a listbox titled ‘Select from the following members’, which displays all of the group members (if any exist).

(i) A set of buttons that support operations on group members is created at step 712. These buttons comprise of:

(1) Add Member: This button is used to add a new user to the currently selected NIS group.

(2) Delete Member: This button is used to delete a currently selected member from the currently selected NIS group.

The steps needed to create, modify, and delete a NIS group, and the steps needed to add and remove members from an existing NIS group are mentioned next.

Creating A New NIS Group

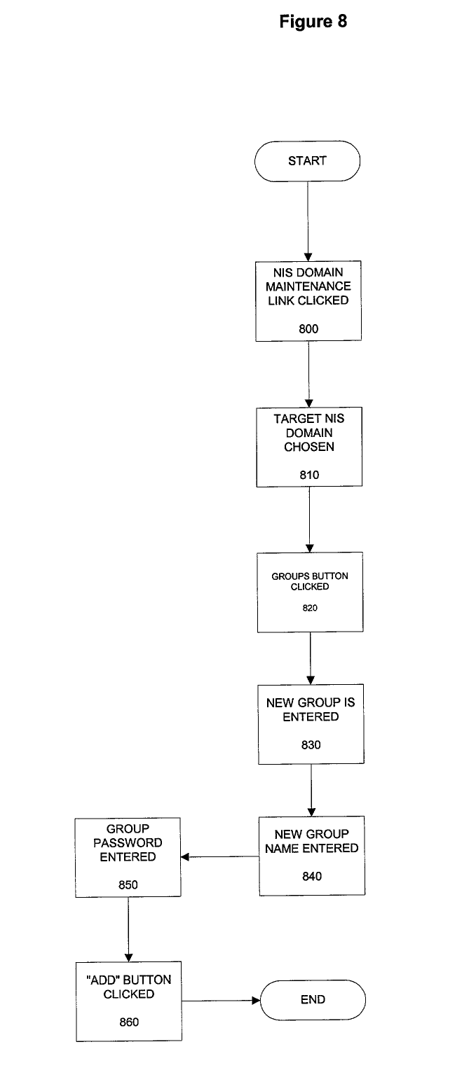

Creating a new NIS group, according to one embodiment of the present invention, is illustrated in FIG. 8, where at:

Step 800: The ‘NIS Domain Maintenance’ link is chosen from the NetAdmin navigation menu. NetAdmin displays the ‘NIS Domain Maintenance’ screen with all text fields empty.

Step 810: The target NIS domain is selected from the NIS Domains' listbox.

Step 820: The “Groups” button is clicked. NetAdmin now displays a ‘NIS Group Maintenance’ screen with all text fields empty except for any groups that exist for the selected NIS domain.

Step 830: The new group name is entered. This name cannot already exist in the currently selected NIS domain, or in a global group.

Step 840: The new group number is entered. This number cannot already exist in the currently selected NIS domain, or in a global group.

Step 850: It is not mandatory to set a group password, but if one is chosen then it has to be entered twice in the two text fields right of the ‘Group Password’ label. This is to ensure that the password was properly entered.

Step 860: The “Add” button is clicked to add a new NIS group.

Modify Information Of An Existing NIS Group

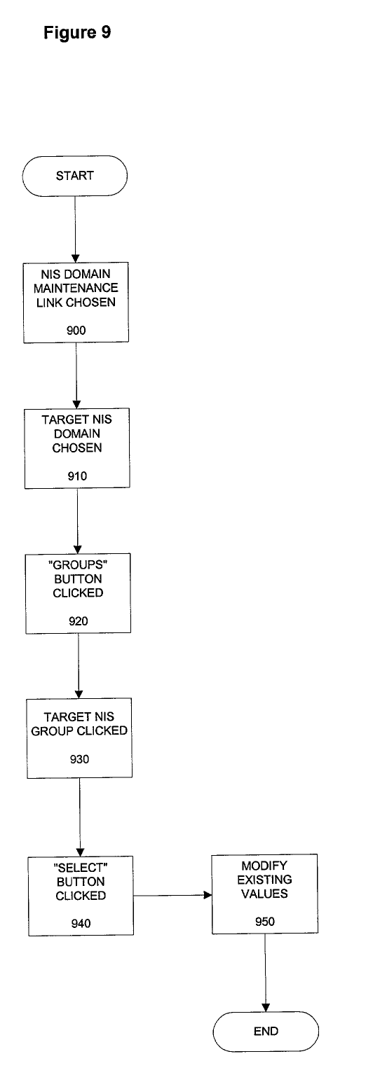

According to one embodiment of the present invention, it is possible to modify the Group Name, Group Number, and Group Password fields using the NIS Domain Maintenance screen. This is illustrated in FIG. 9, where:

Step 900: The ‘NIS Domain Maintenance’ link from the NetAdmin navigation menu is chosen. NetAdmin displays the ‘NIS Domain Maintenance’ screen with all text fields empty.

Step 910: The target NIS domain from the NIS Domains' listbox is chosen.

Step 920: The “Groups” button is clicked. NetAdmin now displays a ‘NIS Group Maintenance’ screen with all text fields empty except for any groups that exist for the selected NIS domain.

Step 930: The target NIS group from the NIS Groups' listbox is clicked.

Step 940: The “Select” button is clicked. NetAdmin redisplays the screen with the components displaying the information for the selected NIS group.

Step 950: Modifications to the existing values are made.

Step 960: The “Modify” button is clicked to record modifications made at step 950 above.

Deleting An Existing NIS Group

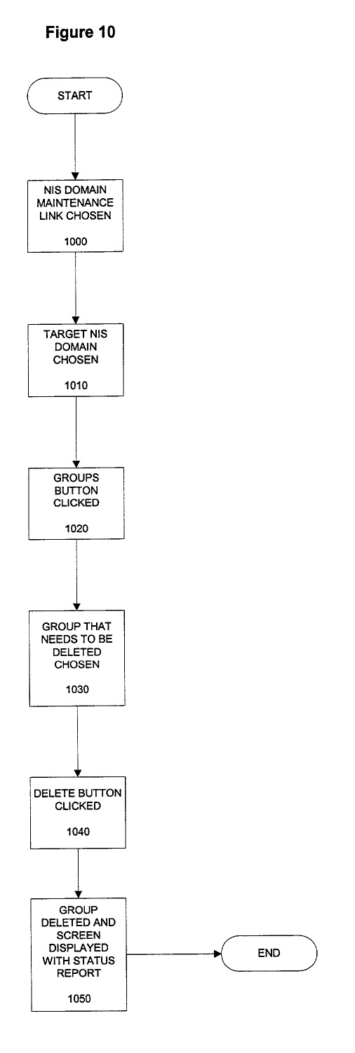

Deleting an existing NIS group, according to one embodiment of the present invention, is illustrated in FIG. 10. Since there is no confirmation when deleting NIS groups, any members that exist in the groups deleted also get deleted. The steps in deleting a NIS group are described below, where:

Step 1000: The ‘NIS Domain Maintenance’ link from the NetAdmin navigation menu is chosen. NetAdmin displays a ‘NIS Domain Maintenance’ screen with all text fields empty.

Step 1010: The target NIS domain from the NIS Domains' listbox is chosen.

Step 1020: The “Groups” button is clicked next. NetAdmin now displays a ‘NIS Group Maintenance’ screen with all text fields empty except for any groups that exist for the selected NIS domain.

Step 1030: The group that needs to be deleted in the NIS Groups' listbox is highlighted.

Step 1040: The “Delete” button is clicked. NetAdmin deletes the group and redisplays the screen with a status message, which is seen at step 1050.

New members can be added or removed from existing NIS groups. These two features are explained next.

Adding Members To An Existing NIS Group

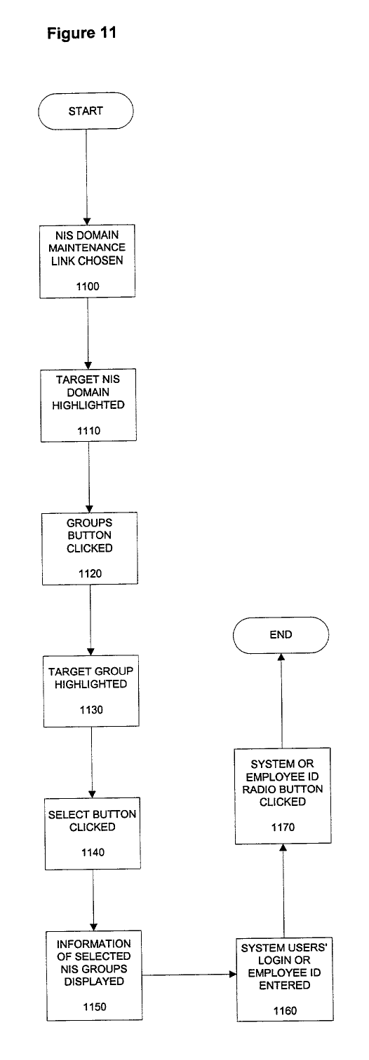

Adding members to an existing NIS group, according to one embodiment of the present invention, is illustrated in FIG. 11, where:

Step 1100: The ‘NIS Domain Maintenance’ link from the NetAdmin navigation menu is chosen. NetAdmin displays a ‘NIS Domain Maintenance’ screen with all text fields empty.

Step 1110: The target NIS domain from the NIS Domains' listbox is highlighted next.

Step 1120: The “Groups” button is clicked. NetAdmin now displays a ‘NIS Group Maintenance’ screen with all text fields empty except for any groups that exist for the selected NIS domain.

Step 1130: The target group in the NIS Groups' listbox is highlighted next.

Step 1140: The “Select” button is clicked. NetAdmin redisplays the screen with the components displaying the information for the selected NIS group, which is seen at step 1150.

Step 1160: The name of the system user's login, or the employee ID is entered next. By using the employee ID as a key to add a person allows NetAdmin to automatically remove a person when that person leaves the company.

Step 1170: The “System” or “Employee ID” radio button is clicked as appropriate.

Removing Members From An Existing NIS Group

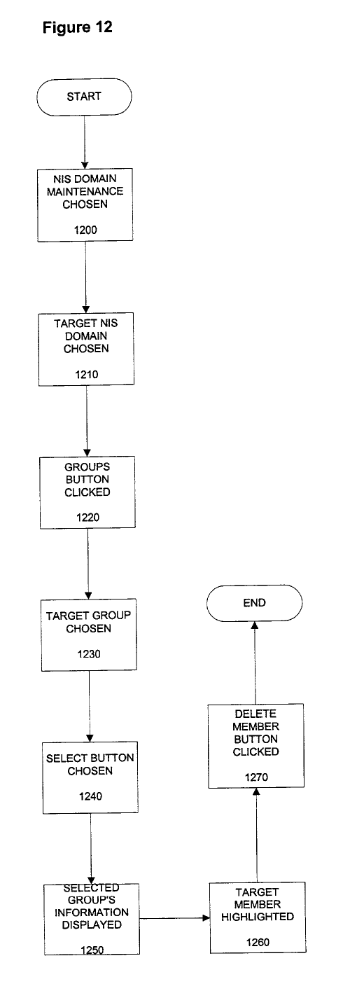

Deleting existing members from an existing NIS group, according to one embodiment of the present invention, is illustrated in FIG. 12, where:

Step 1200: The ‘NIS Domain Maintenance’ link from the NetAdmin navigation menu is chosen. NetAdmin displays the ‘NIS Domain Maintenance’ screen with all text fields empty.

Step 1210: The target NIS domain from the NIS Domains' listbox is highlighted next.

Step 1220: The “Groups” button is clicked next. NetAdmin now displays a ‘NIS Group Maintenance’ screen with all text fields empty except for any groups that exist for the selected NIS domain.

Step 1230: The target group in the NIS Groups' listbox is clicked next.

Step 1240: The “Select” button is clicked next. NetAdmin redisplays the screen with the components displaying the information for the selected NIS group, which is seen at step 1250.

Step 1260: The target group member in the Group Members' listbox is highlighted next.

Step 1270: The “Delete Member” button is clicked to delete the highlighted entry at step 1260.

Global NIS Groups

NetAdmin's AMM makes it possible to create and maintain global NIS groups, which appear in all NIS domains that are converted to a new format. The group name, number, and members will remain the same in the new format. Other limitations include a group name and number that are not already in use by a group in any converted NIS domain or by any other global group can be added. The creation and maintenance of these NIS global groups is explained in further detail below.

To Create A Global NIS Group

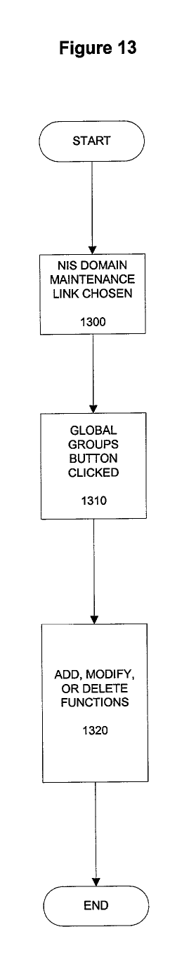

The creation of a new global NIS group, according to one embodiment of the present invention, is illustrated in FIG. 13, where:

Step 1300: The ‘NIS Domain Maintenance’ link from the NetAdmin navigation menu is chosen. NetAdmin displays the ‘NIS Domain Maintenance’ screen with all text fields empty.

Step 1310: The “Global Groups” button is clicked. NetAdmin displays the ‘NIS Domain Maintenance’ screen with all text fields empty.

Step 1320: The Add, Modify, and Delete functions follow the same steps in the NIS Groups section seen above in FIGS. 8, 9, and 10 respectively.

NIS System Users Maintenance

System users are accounts, for example UNIX accounts, that do not belong to a human. In other words, these are users that provide a way to create an account that an application can use to perform a variety of support tasks. For example, if a “cron” entry needs to be created and it is not desired to run the command as ‘root’, one can set up a system user from whose account the “cron” job can be run as desired. System users are either associated with a specific NIS domain, or are global system users.

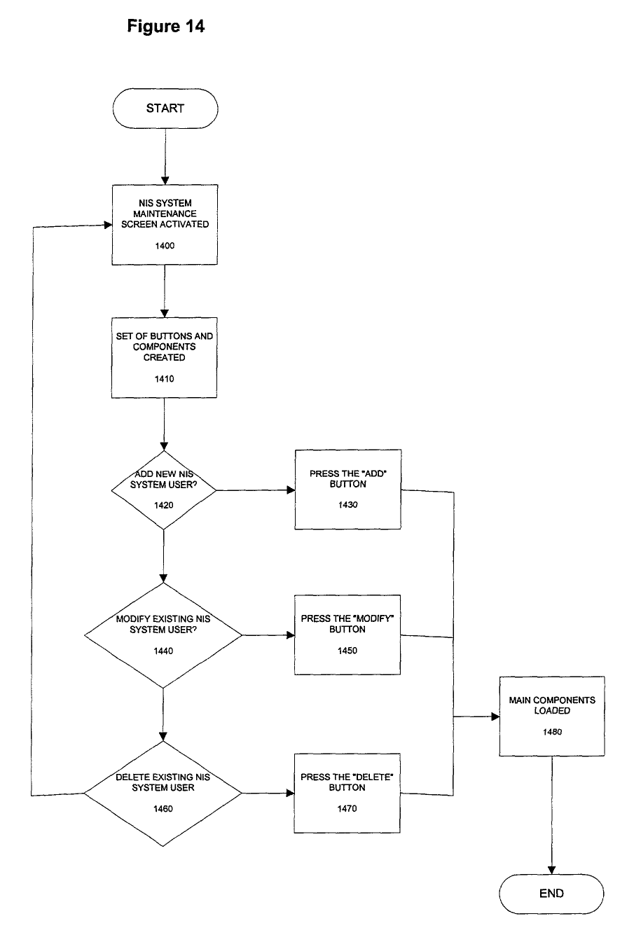

The NIS System Users Maintenance screen, according to one embodiment of the present invention, is illustrated in FIG. 14. At step 1400, a NIS System Users Maintenance screen is activated. At step 1410, it starts up with a set of components and buttons that support selecting, creating, or deleting a NIS system user. If a new NIS system user is needed at step 1420, then a new NIS system user can be added to the list by entering the relevant information and clicking the “Add” button at step 1430. If an existing NIS system user needs modification at step 1440, then it can be modified at step 1450 by clicking the “Modify” button. If an existing NIS system user needs to be deleted at step 1460, then it is removed by clicking on the “Delete” button at step 1470.

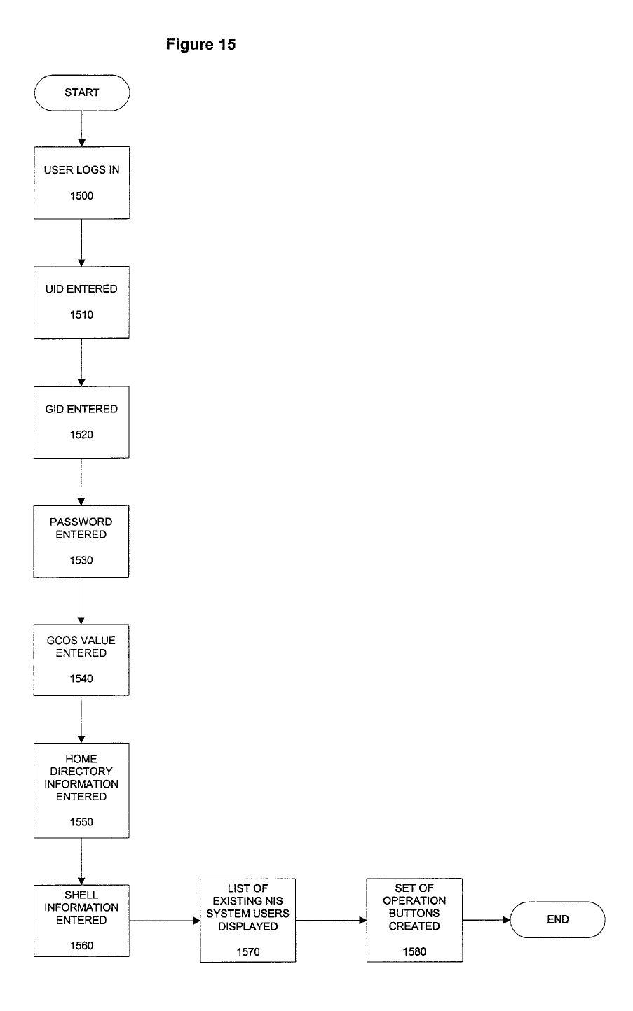

The NIS System User Maintenance screen can only be accessed by clicking on either the ‘NIS System Users’ or the ‘Global NIS System Users’ button in the ‘NIS Domain Maintenance’ screen. At step 1480, the main components, which are locations that require user input, of this screen along with their functionality are loaded. These components are discussed in further detail below, and one embodiment of the present invention is illustrated in FIG. 15, where:

(a) Login: User logins in at step 1500. This is the login for the system user, which is added to the generated NIS files. All logins are lower case characters, and no logins can be used which are already in use by a person, by another system user in the current selected domain, by a global system user, or by any secondary alias of a person.

(b) UID: User id (UID) entered at step 1510. This is the Unix UID for the NIS system user, and it comprises of all digits.

(c) Group ID: Group id (GID) entered at step 1520. This is the Unix GID for the NIS system user, and it comprises of all digits.

(d) Password: Password entered at step 1530. A password is needed for all system users, which must be duplicated in both the text fields provided for the password. This ensures that the password was correctly entered.

(e) GCOS: GCOS value entered at step 1540. This is the GCOS value for the system user that describes the purpose of the system user.

(f) Home Directory: Home directory information entered at step 1550. This is the mount point for the system user's home directory, and is not a mandatory field.

(g) Shell: Shell information entered at step 1560. This is the shell for the system user, and is not a mandatory field.

(h) List: This is a listbox titled ‘Select from the following system users’, which displays all of the existing NIS system users (if any exist), which is seen at step 1570.

(i) A set of buttons that support operations on system users are created at step 1580, and comprise of:

(1) Select: This button is used to load the information for an existing NIS system user.

(2) Add: This button is used to create a new NIS system user.

(3) Modify: This button is used to modify the currently selected NIS system user.

(4) Delete: This button is used to delete the currently selected NIS system user. There is no confirmation when deleting a NIS system user.

The steps needed to create, modify, and delete a NIS system user are mentioned next.

Creating A New NIS System User

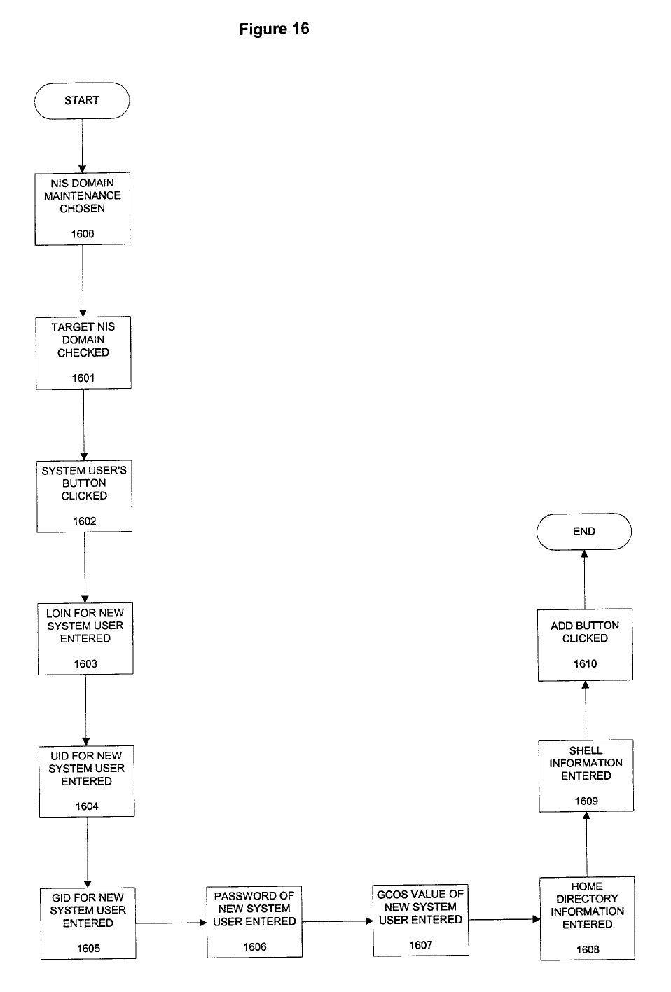

Creating a new NIS system user, according to one embodiment of the present invention, is illustrated in FIG. 16, where:

Step 1600: The ‘NIS Domain Maintenance’ link from the NetAdmin navigation menu is chosen. NetAdmin displays the ‘NIS Domain Maintenance’ screen with all text fields empty.

Step 1601: The target NIS domain from the NIS Domains' listbox is clicked.

Step 1602: The “System Users'” button is clicked. NetAdmin now displays a ‘NIS System Users Maintenance’ screen with all text fields empty except for any system users that exist for the selected NIS domain.

Step 1603: The login for the new system user is entered.

Step 1604: The UID for the new system user is entered.

Step 1605: The GID for the new system user is entered.

Step 1606: The password for the new system user is entered in both text fields.

Step 1607: The GCOS value for the new system user is entered.

Step 1608: The home directory information for the new system user is entered.

Step 1609: The shell information for the new system user is entered.

Step 1610: The “Add” button is clicked to add a new NIS system user.

Modifying Information Of An Existing NIS System User

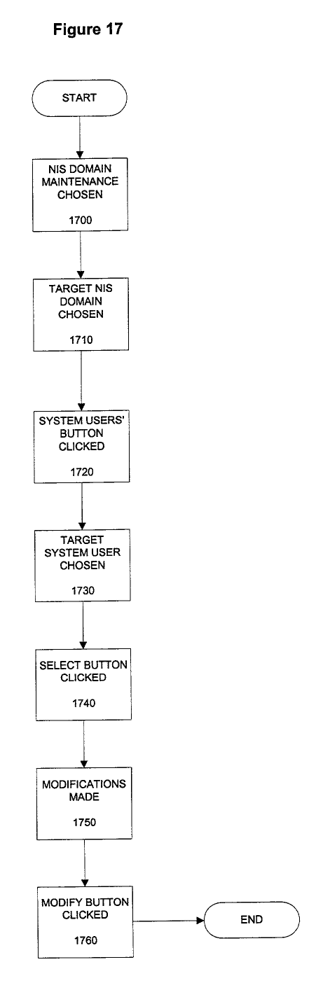

It is possible to modify the login, UID, GID, password, GCOS, home directory, and shell fields using the ‘NIS Group Maintenance’ screen. One embodiment of the present invention is illustrated in FIG. 17, where:

Step 1700: The ‘NIS Domain Maintenance’ link from the NetAdmin navigation menu is chosen. NetAdmin displays the ‘NIS Domain Maintenance’ screen with all text fields empty.

Step 1710: The target NIS domain from the NIS Domains' listbox is selected.

Step 1720: The “System Users”' button is clicked. NetAdmin now displays a ‘NIS System Users Maintenance’ screen with all text fields empty except for any system users that exist for the selected NIS domain.

Step 1730: The target system user from the ‘Select System Users’ listbox is chosen.

Step 1740: The “Select” button is clicked. NetAdmin redisplays the screen with the components displaying the information for the selected NIS system users.

Step 1750: Modifications to the existing values made.

Step 1760: “Modify” button clicked to register any modifications made at step 1750 above.

Deleting An Existing NIS System User

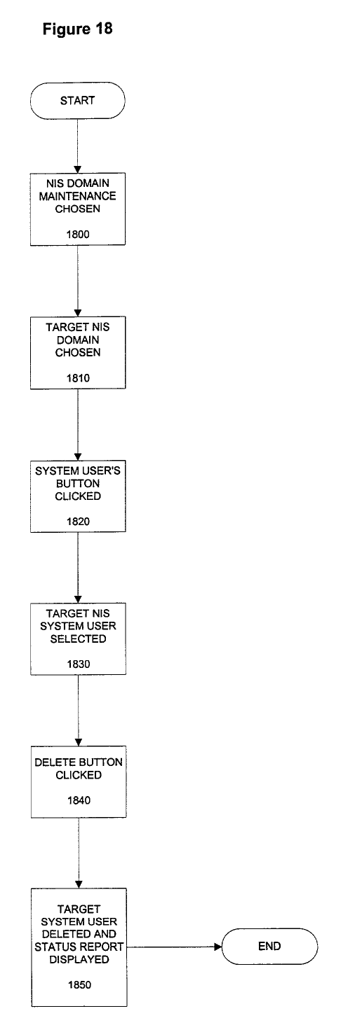

Deleting an existing NIS system user, according to one embodiment of the present invention, is illustrated in FIG. 18, where:

Step 1800: The ‘NIS Domain Maintenance’ link from the NetAdmin navigation menu is chosen. NetAdmin displays the ‘NIS Domain Maintenance’ screen with all text fields empty.

Step 1810: The target NIS domain from the NIS Domains' listbox is chosen.

Step 1820: The “System Users”' button is clicked. NetAdmin now displays a ‘NIS System User Maintenance’ screen with all text fields empty except for any system users that exist for the selected NIS domain.

Step 1830: The system user that needs to be deleted in the NIS System Users' listbox is chosen.

Step 1840: The “Delete” button is clicked. NetAdmin deletes the system user and redisplays the screen with a status message at step 1850.

Global NMS System User

NetAdmin's AMM makes it possible to create and maintain global NIS system users, which appear in all NIS domains that are converted to a new format. The login, UHD, GID, password, GCOS, home directory, and shell remains identical in all converted NIS domains. The login and UID restrictions mentioned in NIS System Users apply to the global system users as well.

To Create A Global System User

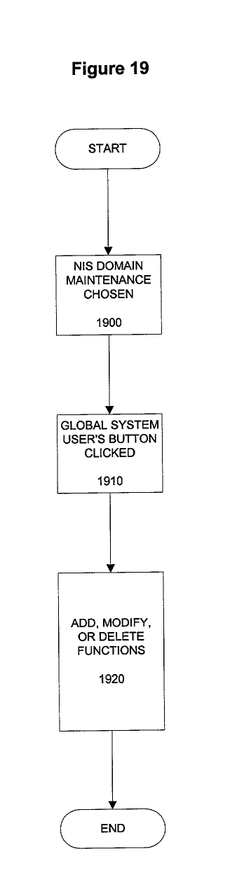

The creation of a new global system user, according to one embodiment of the present invention, is illustrated in FIG. 19, where:

Step 1900: The ‘NIS Domain Maintenance’ link from the NetAdmin navigation menu is chosen. NetAdmin displays the ‘NIS Domain Maintenance’ screen with all text fields empty.

Step 1910: The “Global System Users” button is clicked. NetAdmin displays the ‘NIS System Users’ screen with all text fields empty. Any global system users that exist are displayed in the listbox.

Step 1920: The Add, Modify, and Delete functions follow the same steps in the NIS System Users section seen above in FIGS. 16, 17, and 18 respectively.

General Characteristics Of Present Invention

The following are some of the general characteristics of the present invention, and include:

(a) The data displayed in all NetAdmin screens is static data. This means that it is possible for the data to have been changed in the database since the time it is loaded in the screen, but this change is not reflected in the screen. Selecting the NIS Domain Maintenance link in the toolbar will always cause the data to be reloaded, hence ensuring a screen with the current data.

(b) If data is modified, but the “Modify” button is not pressed for over an hour, the data does not get updated. This happens because the operation is invalidated by the authentication process after an hour.

(c) It may take up to 4 hours for other users to see a newly created NIS domain since NetAdmin uses a caching mechanism to cache frequently accessed data to improve performance. This cache is updated every four hours.

(d) The ‘NIS Group Maintenance’ screen sometimes displays a “*****” in the first password filed until a group is selected.

Embodiment of a Computer Execution Environment

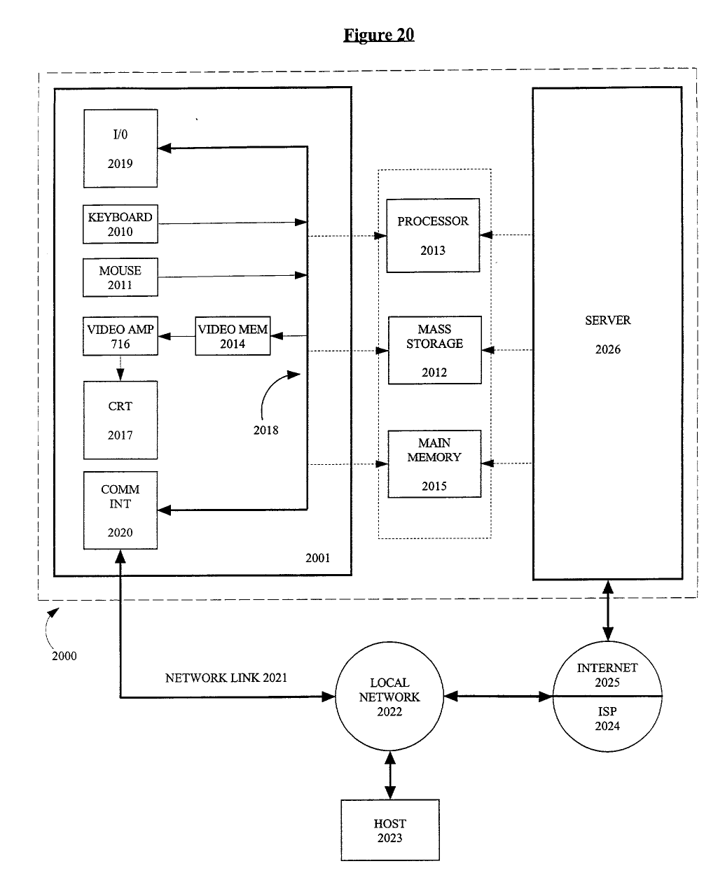

An embodiment of the invention can be implemented as computer software in the form of computer readable code executed in a desktop general purpose computing environment such as environment 2000 illustrated in FIG. 20, or in the form of bytecode class files running in such an environment. A keyboard 2010 and mouse 2011 are coupled to a bidirectional system bus 2018. The keyboard and mouse are for introducing user input to a computer 2001 and communicating that user input to processor 2013.

Computer 2001 may also include a communication interface 2020 coupled to bus 2018. Communication interface 2020 provides a two-way data communication coupling via a network link 2021 to a local network 2022. For example, if communication interface 2020 is an integrated services digital network (ISDN) card or a modem, communication interface 2020 provides a data communication connection to the corresponding type of telephone line, which comprises part of network link 2021. If communication interface 2020 is a local area network (LAN) card, communication interface 2020 provides a data communication connection via network link 2021 to a compatible LAN. Wireless links are also possible. In any such implementation, communication interface 2020 sends and receives electrical, electromagnetic or optical signals, which carry digital data streams representing various types of information.

Network link 2021 typically provides data communication through one or more networks to other data devices. For example, network link 2021 may provide a connection through local network 2022 to local server computer 2023 or to data equipment operated by ISP 2024. ISP 2024 in turn provides data communication services through the world wide packet data communication network now commonly referred to as the “Internet” 2025. Local network 2022 and Internet 2025 both use electrical, electromagnetic or optical signals, which carry digital data streams. The signals through the various networks and the signals on network link 2021 and through communication interface 2020, which carry the digital data to and from computer 2000, are exemplary forms of carrier waves transporting the information.

Processor 2013 may reside wholly on client computer 2001 or wholly on server 2026 or processor 2013 may have its computational power distributed between computer 2001 and server 2026. In the case where processor 2013 resides wholly on server 2026, the results of the computations performed by processor 2013 are transmitted to computer 2001 via Internet 2025, Internet Service Provider (ISP) 2024, local network 2022 and communication interface 2020. In this way, computer 2001 is able to display the results of the computation to a user in the form of output. Other suitable input devices may be used in addition to, or in place of, the mouse 2011 and keyboard 2010. I/O (input/output) unit 2019 coupled to bi-directional system bus 2018 represents such P/O elements as a printer, A/V (audio/video) I/O, etc.

Computer 2001 includes a video memory 2014, main memory 2015 and mass storage 2012, all coupled to bidirectional system bus 2018 along with keyboard 2010, mouse 2011 and processor 2013.

As with processor 2013, in various computing environments, main memory 2015 and mass storage 2012, can reside wholly on server 2026 or computer 2001, or they may be distributed between the two. Examples of systems where processor 2013, main memory 2015, and mass storage 2012 are distributed between computer 2001 and server 2026 include the thin-client computing architecture developed by Sun Microsystems, Inc., the palm pilot computing device, Internet ready cellular phones, and other Internet computing devices.

The mass storage 2012 may include both fixed and removable media, such as magnetic, optical or magnetic optical storage systems or any other available mass storage technology. Bus 2018 may contain, for example, thirty-two address lines for addressing video memory 2014 or main memory 2015. The system bus 2018 also includes, for example, a 32-bit data bus for transferring data between and among the components, such as processor 2013, main memory 2015, video memory 2014, and mass storage 2012. Alternatively, multiplex data/address lines may be used instead of separate data and address lines.

In one embodiment of the invention, the processor 2013 is a microprocessor manufactured by Motorola, such as the 680×0 processor or a microprocessor manufactured by Intel, such as the 80×86 or Pentium processor, or a SPARC microprocessor from Sun Microsystems, Inc. However, any other suitable microprocessor or microcomputer may be utilized. Main memory 2015 is comprised of dynamic random access memory (DRAM). Video memory 2014 is a dual-ported video random access memory. One port of the video memory 2014 is coupled to video amplifier 2016. The video amplifier 2016 is used to drive the cathode ray tube (CRT) raster monitor 2017. Video amplifier 2016 is well known in the art and may be implemented by any suitable apparatus. This circuitry converts pixel data stored in video memory 2014 to a raster signal suitable for use by monitor 2017. Monitor 2017 is a type of monitor suitable for displaying graphic images.

Computer 2001 can send messages and receive data, including program code, through the network(s), network link 2021, and communication interface 2020. In the Internet example, remote server computer 2026 might transmit a requested code for an application program through Internet 2025, ISP 2024, local network 2022 and communication interface 2020. The received code may be executed by processor 2013 as it is received, and/or stored in mass storage 2012, or other non-volatile storage for later execution. In this manner, computer 2000 may obtain application code in the form of a carrier wave. Alternatively, remote server computer 2026 may execute applications using processor 2013, and utilize mass storage 2012, and/or video memory 2015. The results of the execution at server 2026 are then transmitted through Internet 2025, ISP 2024, local network 2022, and communication interface 2020. In this example, computer 2001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method for an account management module user interface for servers is described in conjunction with one or more specific embodiments. The invention is defined by the following claims and their full scope of equivalents.

We claim:,

1. A method for an account management module user interface for a server comprising:
providing one or more first servlets for adding user information;
providing one or more second servlets for modifying user information; and
providing one or more third servlets for deleting user information, where said first, second, and third servlets are components of a user interface.

2. The method of claim 1 wherein said user is human.

3. The method of claim 1 wherein said user is other system related machines or programs.

4. The method of claim 1 where said first, second, and third servlets are written in a platform independent programming language.

5. The method of claim 4 wherein said platform independent programming language is Java.

6. The method of claim 1 wherein said first, second, and third servlets provide one or more screens in a browser.

7. The method of claim 6 wherein one of said screens displays a NIS password of said user.

8. The method of claim 6 wherein one of said screens displays a group maps of said user.

9. The method of claim 6 wherein one of said screens displays an auto_home maps of said user.

10. The method of claim 6 wherein said screens are interactive.

11. A computer program product comprising:
a computer usable medium having computer readable program code embodied therein for an account management module user interface for a server, said computer program product comprising:
computer readable program code configured to cause said computer to provide one or more first servlets for adding user information;
computer readable program code configured to cause said computer to provide one or more second servlets for modifying user information; and
computer readable program code configured to cause said computer to provide one or more third servlets for deleting user information, where said first, second, and third servlets are components of a user interface.

12. The computer program product of claim 11 wherein said user is human.

13. The computer program product of claim 9 wherein said user is other system related machines or programs.

14. The computer program product of claim 11 where said first, second, and third servlets are written in a platform independent programming language.

15. The computer program product of claim 14 wherein said platform independent programming language is Java.

16. The computer program product of claim 11 wherein said first, second, and third servlets provide one or more screens in a browser.

17. The computer program product of claim 16 wherein one of said screens displays a NIS password of said user.

18. The computer program product of claim 16 wherein one of said screens displays a group maps of said user.

19. The computer program product of claim 16 wherein one of said screens displays an auto_home maps of said user.

20. The computer program product of claim 16 wherein said screens are interactive.

21. An apparatus comprising:
one or more first servlets configured to add user information;
one or more second servlets configured to modify user information; and
one or more third servlets for deleting user information.

22. The apparatus of claim 21 wherein said user is human.

23. The apparatus of claim 21 wherein said user is other system related machines or programs.

24. The apparatus of claim 21 where said first, second, and third servlets are written in a platform independent programming language.

25. The apparatus of claim 24 wherein said platform independent programming language is Java.

26. The apparatus of claim 21 wherein said first, second, and third servlets provide one or more screens in a browser.

27. The apparatus of claim 26 wherein one of said screens displays a NIS password of said user.

28. The apparatus of claim 26 wherein one of said screens displays a group maps of said user.

29. The apparatus of claim 26 wherein one of said screens displays an auto_home maps of said user.

30. The apparatus of claim 26 wherein said screens are interactive.
